(19) United States
(12) Patent Application Publication
(10) Pub. No.: US 2025/0207629 A1
(43) Pub. Date: Jun. 26, 2025

(54) AIRFOIL JOURNAL BEARING

(71) Applicant: Hanon Systems, Daejeon (KR)

(72) Inventors: Jong Sung LEE, Daejeon (KR); Hyun Chil KIM, Daejeon (KR); Gunwoong PARK, Daejeon (KR); Min Gyu PARK, Daejeon (KR); Chi Yong PARK, Daejeon (KR); Yeol Woo SUNG, Daejeon (KR); Kyu Sung CHOI, Daejeon (KR)

(21) Appl. No.: 18/274,488

(22) PCT Filed: Dec. 10, 2021
(86) PCT No.: PCT/KR2021/018709

§ 371 Date: Mar. 20, 2025

(30) Foreign Application Priority Data
Feb. 19, 2021 (KR) 10-2021-0022349

(51) Int. Cl. F16C 17/02

(52) U.S. Cl. CPC F16C 17/024

(57) ABSTRACT

The present invention provides an airfoil journal bearing including a bearing housing, a bump foil provided inside the bearing housing, formed in a circumferential direction, and coupled to the bearing housing, and a top foil provided inside the bump foil, formed in the circumferential direction, and having one end, based on the circumferential direction, fixedly coupled to the bearing housing, and the other end configured as a free end, in which the other end, which is the free end of the top foil, is formed to exceed one end in a direction in which the top foil extends based on one end fixed to the bearing housing, such that the other end of the top foil is disposed to overlap one side in the circumferential direction. Therefore, when a rotor disposed inside the top foil rotates, the pressure of air flowing along the rotor is prevented from being lost at a portion adjacent to the free end of the top foil, thereby improving the rigidity and damping performance implemented by fluid dynamic pressure of the airfoil journal bearing.

### TECHNICAL FIELD

The present invention relates to an airfoil journal bearing configured to support a radial load of a rotor.

### BACKGROUND ART

An airfoil bearing refers to a bearing that supports a load by means of pressure generated as air, which is a fluid having a viscosity, is introduced between foils that adjoin a rotor or bearing disc when a rotor (or rotary shaft) rotates at high speed.

Further, among the airfoil bearings, an airfoil journal bearing refers to a bearing configured to support a radial load of the rotor that is applied in a direction perpendicular to the rotor.

As illustrated in FIG. 1, in a general airfoil journal bearing, a bump foil 2 is installed along an inner circumferential surface 1b of a hollow portion 1a of a bearing housing 1, and a top foil 3 is disposed inside the bump foil 2. A rotor 4 (or a rotary shaft) is disposed inside the top foil 3, such that the rotor may rotate in a state in which an inner circumferential surface of the top foil 3 and an outer circumferential surface of the rotor 4 are spaced apart from each other. Further, the bump foil 2 and the top foil 3 each have one end based on a circumferential direction, and one end has a bent portion bent outward in the radial direction. The bent portions 2a and 3a are fixedly inserted into a groove 1c formed in the bearing housing 1. Therefore, in a state in which the rotor is stopped, the rotor is brought into contact with and supported on a lower side of the inner circumferential surface of the top foil. When the rotor operates and rotates, pressure of air between a lower side of the rotor and the top foil increases, and the rotor floats from the lower side of the inner circumferential surface of the top foil and rotates.

However, in the general airfoil journal bearing, one end of the top foil is fixed to the bearing housing, the other end of the top foil is configured as a free end, and the free end is spaced apart from one side.

For this reason, there is a problem in that when the rotor rotates at high speed, the pressure of air flowing along the rotor is lost between the free end and one side of the top foil, which causes dynamic instability and degrades rigidity and damping performance.

### DOCUMENT OF RELATED ART

### Patent Document

JP 2011-169413 A (Sep. 1, 2011)

### DISCLOSURE

### Technical Problem

The present invention has been made in an effort to solve the above-mentioned problem, and an object of the present invention is to provide an airfoil journal bearing capable of reducing a gap between a top foil and a rotor, which rotates inside the top foil, and preventing pressure of air, which flows along the rotor when the rotor disposed inside the top foil rotates, from being lost at a portion adjacent to a free end of the top foil.

### Technical Solution

To achieve the above-mentioned object, the present invention provides an airfoil journal bearing including: a bump foil provided inside a bearing housing, formed in a circumferential direction, and coupled to the bearing housing; and a top foil provided inside the bump foil, formed in the circumferential direction, and having one end, based on the circumferential direction, fixedly coupled to the bearing housing, and the other end configured as a free end, in which the other end, which is the free end of the top foil, is formed to exceed one end in a direction in which the top foil extends based on one end fixed to the bearing housing, such that the other end of the top foil is disposed to overlap one side in the circumferential direction.

In addition, the top foil may be provided as two or more top foil including an outer top foil and an inner top foil disposed inside the outer top foil, and the other end of each of the outer and inner top foils may be disposed to overlap one side of the inner top foil.

In addition, directions in which the outer and inner top foils extend may be identical to each other based on one end fixed to the fixed bearing housing.

In addition, an overlap angle range θi of the inner top foil in which the other end of the inner top foil overlaps one side of the inner top foil may be larger than an overlap angle range θo of the outer top foil in which the other end of the outer top foil overlaps one side of the inner top foil.

In addition, the overlap angle range θi of the inner top foil may be 12 to 15 degrees, and the overlap angle range θo of the outer top foil may be 5 to 7 degrees.

In addition, the free end of the outer top foil and the free end of the inner top foil may be in contact with and supported on an inner circumferential surface of one side of the inner top foil.

In addition, one fixed end of the top foil may be disposed at a lower side of the bearing housing.

In addition, one fixed end of the top foil may be disposed at an upper side of the bearing housing

In addition, the top foil may extend to exceed 360 degrees in the circumferential direction based on one fixed end.

In addition, the bump foil and the top foil may be divided into two or more foils in the circumferential direction, a range of each of the divided bump foils and the divided top foils may be less than 360 degrees, one end of each of the divided bump foils and the divided top foils may be coupled to the bearing housing, the other end of each of the divided bump foils and the divided top foils may be configured as a free end, and the other end of one top foil may be disposed to overlap one side of adjacent another top foil.

In addition, among the divided top foils, one fixed end of one top foil may be disposed at a lower side of the bearing housing, and one fixed end of another top foil may be disposed at an upper side of the bearing housing.

### Advantageous Effects

According to the present invention, in the airfoil journal bearing configured to support a radial load of the rotor, when the air, which is allowed to flow by the high-speed rotation of the rotor, passes through a portion adjacent to the free end of the top foil, the pressure of air, which flows along the rotor when the rotor disposed inside the top foil rotates, is prevented from being lost at the portion adjacent to the free end of the top foil. Therefore, it is possible to improve the dynamic stability of the airfoil journal bearing.

In addition, the gap between the top foil and the rotor, which rotates inside the top foil, may be reduced, which may improve the rigidity and damping performance implemented by fluid dynamic pressure of the airfoil journal bearing.

In addition, it is possible to easily adjust the gap between the rotor and the top foil by changing the length of the top foil in the circumferential direction without processing the bearing housing.

### BRIEF DESCRIPTION OF THE DRAWINGS

FIG. 1 is a cross-sectional view illustrating an airfoil journal bearing in the related art.

FIGS. 2 and 3 are cross-sectional and partially enlarged views illustrating an airfoil journal bearing according to a first embodiment of the present invention.

FIGS. 4A and 4B are cross-sectional views illustrating top foils having a relatively short length and top foils having a relatively long length in the airfoil journal bearing according to the first embodiment of the present invention.

FIGS. 5A and 5B are graphs illustrating X-axis direction rigidity and Y-axis direction rigidity with respect to rotational speeds of a rotor for respective the amount of decrease in inner gaps (rp value) in the airfoil journal bearing according to the first embodiment of the present invention.

FIG. 6 is a cross-sectional view illustrating an airfoil journal bearing according to a second embodiment of the present invention.

FIG. 7 is a cross-sectional view illustrating an airfoil journal bearing according to a third embodiment of the present invention.

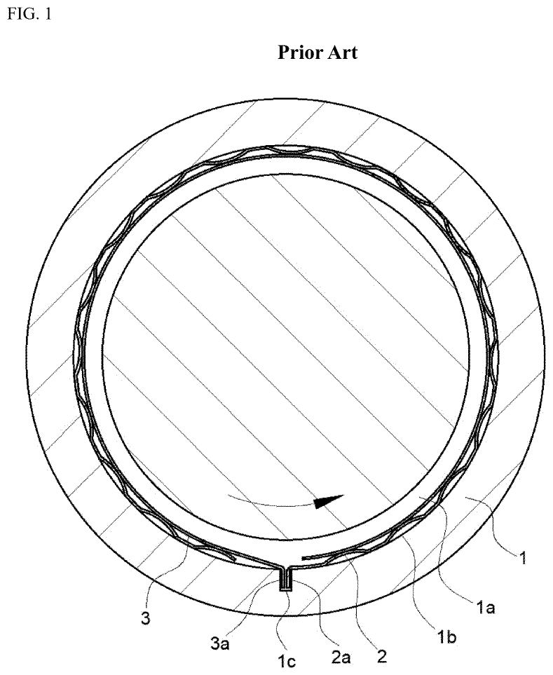

### MODE FOR INVENTION

Hereinafter, an airfoil journal bearing of the present invention configured as described above will be described in detail with reference to the accompanying drawings.

### Embodiment 1

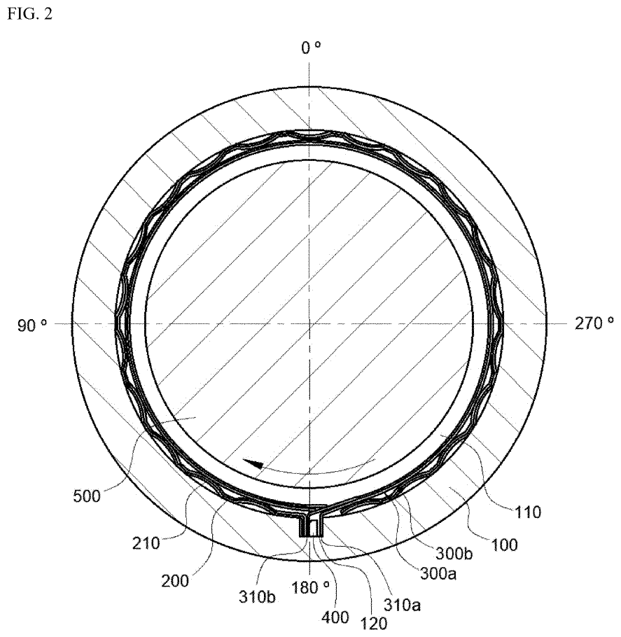

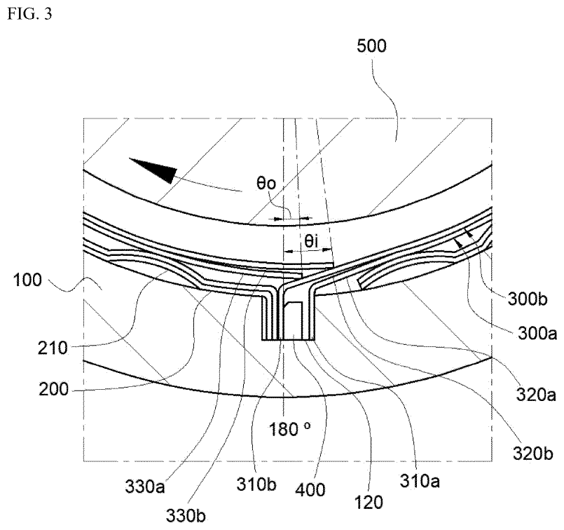

FIGS. 2 and 3 are cross-sectional and partially enlarged views illustrating an airfoil journal bearing according to a first embodiment of the present invention.

As illustrated, the airfoil journal bearing according to the first embodiment of the present invention may broadly include a bearing housing 100, a bump foil 200, and a top foil.

The bearing housing 100 has therein a hollow portion 110 having two opposite surfaces penetrated in an axial direction. A key groove 120 may be formed to communicate with the hollow portion 110. The key groove 120 may be continuously formed in a longitudinal direction, which is the axial direction, and formed concavely in the radial direction in an inner circumferential surface of a lower side of the bearing housing 100.

The bump foil 200 is disposed inside the hollow portion 110 of the bearing housing 100. One end of the bump foil 200 based on the circumferential direction has a bent portion bent outward in the radial direction, and the bent portion may be inserted and coupled into the key groove 120. Further, the bump foil 200 may be disposed in the circumferential direction while being in close contact with the inner circumferential surface of the bearing housing 100. The bump foil 200 may be formed in a plate shape with a small thickness and have a plurality of elastic bumps 210 spaced apart from one another in the circumferential direction and protruding convexly inward. In addition, as illustrated, the bump foil 200 may be provided as two or more bump foils 200. In addition, the bump foil 200 may extend counterclockwise from one end fixed to the bearing housing 100. In addition, the bump foil 200 may be formed in various ways.

The top foil may be provided inside the bump foil 200 and formed in the circumferential direction. Further, one or more sheets of top foils may be provided. Hereinafter, an embodiment will be described in which two top foils are provided. The top foils may include an outer top foil 300a and the inner top foil 300b. Bent portions 310a and 310b, which are bent outward in the radial direction, may be respectively provided at one end of the outer top foil 300a and one end of the inner top foil 300b based on the circumferential direction. The bent portions 310a and 310b may be inserted into the key groove 120, such that the outer top foil 300a and the inner top foil 300b may be fixed. For example, a top foil key 400 may be coupled to the bent portion 310b of the inner top foil 300b, such that the bent portion 310b of the inner top foil 300b and the top foil key 400 may be inserted and coupled into the key groove 120 of the bearing housing 100. Further, connection portions 320a and 320b may extend counterclockwise from upper ends of the bent portions 310a and 310b of the outer and inner top foils 300a and 300b, and curved portions 330a and 330b may extend counterclockwise from ends, i.e., right ends of the connection portions 320a and 320b. That is, the directions in which the outer top foil 300a and the inner top foil 300b extend may be identical to each other based on one fixed end. In this case, the connection portions 320a and 320b may be formed to be gradually distant radially outward clockwise from extension lines defined by the inner circumferential surfaces of the curved portions 330a and 330b. Further, for example, inner circumferential surfaces of the curved portions 330a and 330b may each have a circular arc shape. In addition, the other end of each of the outer and inner top foils 300a and 300b based on the circumferential direction is configured as a free end, such that the ends of the curved portions 330a and 330b may be configured as free ends. Therefore, the outer and inner top foils 300a and 300b extend counterclockwise while exceeding 360 degrees in the circumferential direction based on the bent portions 310a and 310b. Therefore, the other end of each of the outer and inner top foils 300a and 300b, which is a portion that exceeds 360 degrees, may be disposed to overlap the bent portion 310b and the connection portion 320b of the inner top foil 300b in the circumferential direction. That is, the outer and inner top foils 300a and 300b may each have a region in which one end and the other end overlap each other in the circumferential direction by a particular angle. The other end of each of the outer and inner top foils 300a and 300b may be disposed radially inward from one end of the inner top foil 300b. In this case, the other end, i.e., the free end of each of the outer and inner top foils 300a and 300b may be disposed radially outward from the extension line defined by the inner circumferential surface of the curved portion 330b of the inner top foil 300b. In addition, a rectilinearly outer side of the other end of each of the outer and inner top foils 300a and 300b may be in contact with and supported on the connection portion 320b in a state in which no external force is applied. That is, the outer and inner top foils 300a and 300b may be manufactured in a flat shape or the outer and inner top foils 300a and 300b may be manufactured so that an inner diameter of the bump foil 200 is larger than an outer diameter of each of the outer and inner top foils 300a and 300b, and then the outer and inner top foils 300a and 300b may be rolled and assembled by being inserted inside the bump foil 200. In this case, the outer and inner top foils 300a and 300b are spread by elasticity, such that the free ends of the outer and inner top foils 300a and 300b may be in contact with and supported on the connection portions 320b of the inner top foil 300b. In addition, as illustrated, only the ends of the free ends of the outer and inner top foils 300a and 300b may be in contact with the connection portions 320b. Alternatively, a partial region of the free end may be in surface contact with and supported on the connection portion 320b. Alternatively, although not illustrated, the other end of each of the outer and inner top foils 300a and 300b may be disposed to be slightly spaced apart from the connection portion 320b in a free state in which no external force is applied. In this case, when a rotor 500 rotates, the free end of each of the outer and inner top foils 300a and 300b may be bent radially outward by pressure of air, such that the end of the free end may be in contact with and supported on the connection portion 320b.

In addition, the rotor 500 may be inserted inside the inner top foil 300b and disposed to be spaced apart from the inner top foil 300b. A coating film made of Teflon or the like may be formed on an inner circumferential surface of the inner top foil 300b to reduce friction caused by the contact when the rotor 500 rotates. Therefore, when the rotor 500 rotates at high speed clockwise inside the inner top foil 300b, the rotor 500 is floated and spaced apart from the inner top foil 300b by pressure of flowing air, such that the rotor 500 may smoothly rotate. That is, a rotation direction of the rotor 500 may be a direction opposite to the direction in which the outer and inner top foils 300a and 300b extend based on the bent portions 310a and 310b fixedly coupled to the bearing housing 100.

Therefore, according to the present invention, when the air, which is allowed to flow by the high-speed rotation of the rotor, passes through a portion adjacent to the free end of the top foil, the pressure of air, which flows along the rotor when the rotor disposed inside the top foil rotates, is prevented from being lost at the portion adjacent to the free end of the top foil. Therefore, it is possible to improve the dynamic stability of the airfoil journal bearing. In addition, the gap between the top foil and the rotor, which rotates inside the top foil, may be reduced, which may improve the rigidity and damping performance implemented by fluid dynamic pressure of the airfoil journal bearing.

In addition, an overlap angle range θi of the inner top foil, in which the other end of the inner top foil 300b overlaps one side of the inner top foil 300b, may be larger than an overlap angle range θo of the outer top foil in which the other end of the outer top foil 300a overlaps one side of the inner top foil 300b. Therefore, it is possible to minimize the hindrance to the flow of air passing through the portion adjacent to the free ends of the outer and inner top foils 300a and 300b.

In addition, the overlap angle range θi of the inner top foil may be 12 to 15 degrees, and the overlap angle range θo of the outer top foil may be 5 to 7 degrees. In this case, if the overlap angle range θi of the inner top foil is 20 degrees or more, driving torque increases, which is disadvantageous in terms of performance. Further, if the overlap angle range θo of the outer top foil is less than 5 degrees and equal to 0 degrees, there may occur an abnormal engagement in which the outer top foil 300a is spread by the motion of the bump foil, the free end is pushed radially outward and does not overlap one side, and the free end is caught by a lateral side of the bent portion 310b of the inner top foil 300b.

In addition, one fixed end of each of the outer and inner top foils 300a and 300b may be disposed at a lower side of the bearing housing 100. Therefore, it is possible to prevent the air pressure from being lost at a portion having an angle of 200 degrees at which maximum pressure is generated in the air pressure field of the portion to which a load is applied when the rotor 500 rotates. Therefore, it is possible to suppress self-excited vibration at a maximum speed of the rotor.

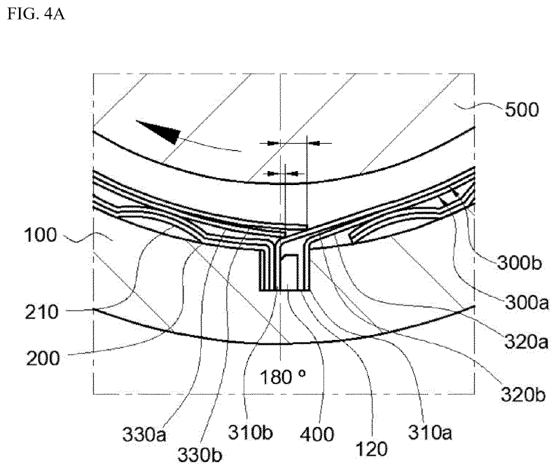

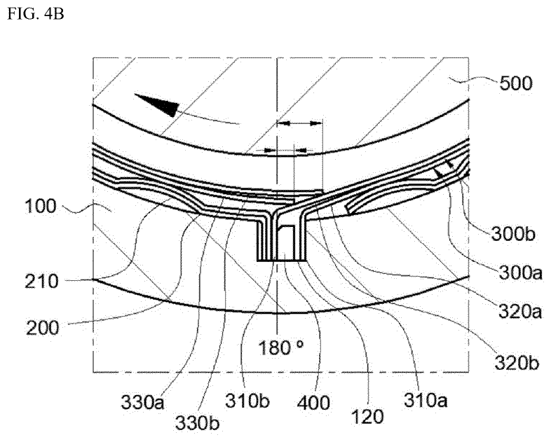

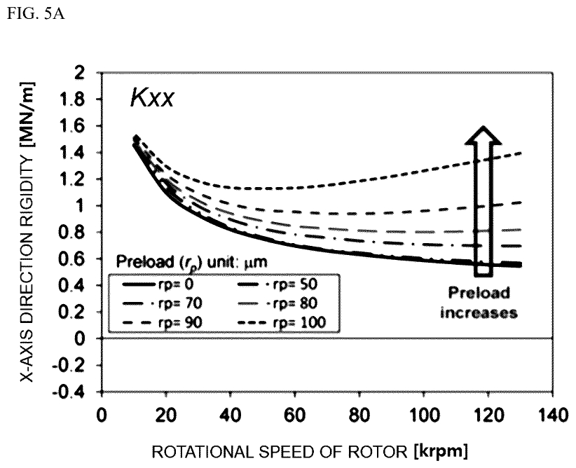

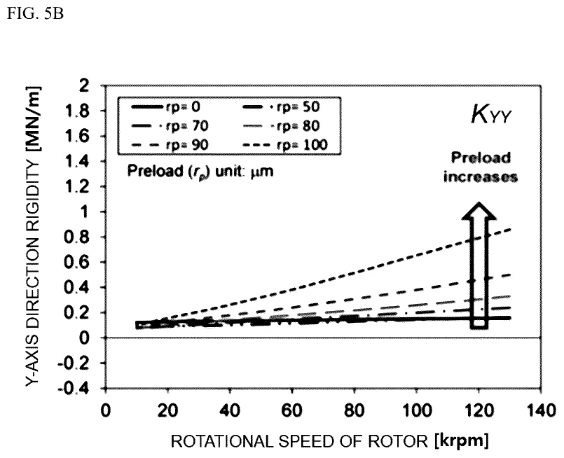

FIGS. 4A and 4B are cross-sectional views illustrating top foils having a relatively short length and top foils having a relatively long length in the airfoil journal bearing according to the first embodiment of the present invention, and FIGS. 5A and 5B are graphs illustrating X-axis direction rigidity and Y-axis direction rigidity with respect to rotational speeds of the rotor for respective the amount of decrease in inner gaps (rp value) in the airfoil journal bearing according to the first embodiment of the present invention.

With reference to FIGS. 4A and 4B, the inner gap may be adjusted depending on lengths of the outer and inner top foils 300a and 300b of the airfoil journal bearing according to the present invention. That is, when the lengths of the outer and inner top foils 300a and 300b are relatively long as illustrated in FIG. 4B, the inner gap, which is a distance between the rotor 500 and the inner top foil 300b, may be reduced in comparison with the case in FIG. 4A in which the lengths of the outer and inner top foils 300a and 300b are relatively short. It can be seen from the experimental result that there is a distinct effect of reducing the inner gap by increasing the lengths of the outer and inner top foils 300a and 300b. The decrease in the inner gap immediately means the improvement of the rigidity and damping performance of the airfoil journal bearing. Further, according to the graphs in FIGS. 5A and 5B, an rp value is a numerical value indicating a value by which the inner gap is reduced. It can be seen that the effect of improving the X-axis direction rigidity (K_{XX}) and Y-axis direction rigidity (K_{YY}) according to the inner gaps increases as a rotational speed of the rotor increases.

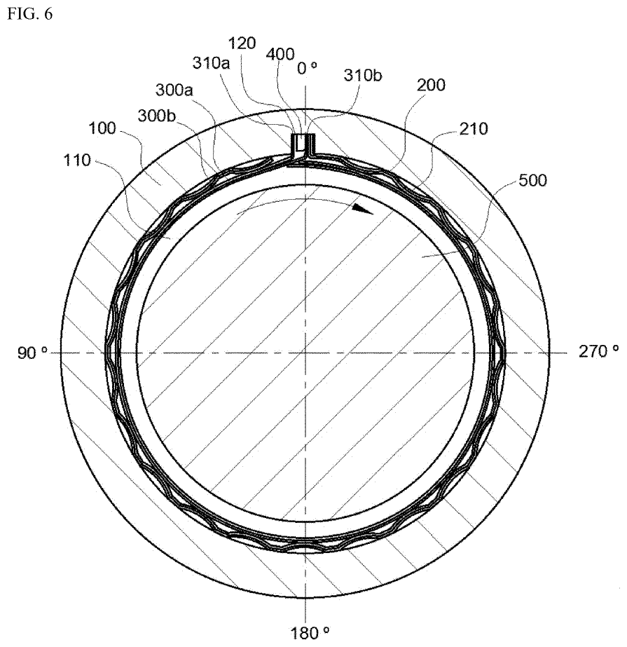

FIG. 6 is a cross-sectional view illustrating an airfoil journal bearing according to a second embodiment of the present invention.

As illustrated, in the airfoil journal bearing according to the second embodiment of the present invention, one fixed end of each of the outer and inner top foils 300a and 300b may be disposed at an upper side of the bearing housing 100. Therefore, it is possible to prevent instability of pressure of air at a portion having an angle of 20 degrees where negative pressure is generated in the air pressure field when the rotor 500 rotates. Therefore, it is possible to improve the dynamic stability.

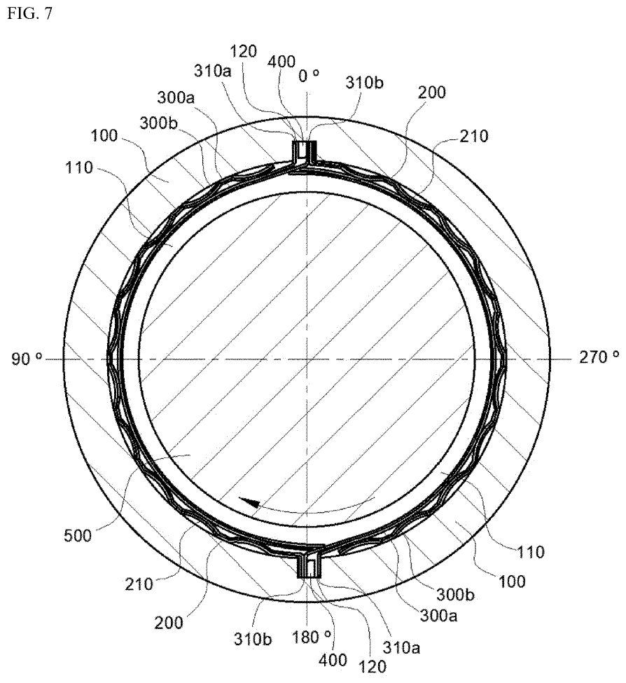

FIG. 7 is a cross-sectional view illustrating an airfoil journal bearing according to a third embodiment of the present invention.

As illustrated, in the airfoil journal bearing according to the third embodiment of the present invention, the bump foil 200 and the outer and inner top foils 300a and 300b may be divided into two or more foils in the circumferential direction. Further, the divided bump foils 200, the divided outer top foils 300a, and the divided inner top foils 300b may each be formed within a forming angle range of 360 degrees. One end of each of the divided bump foils 200, the divided outer top foils 300a, and the divided inner top foils 300b may be fixed to the bearing housing, and the other end of each of the divided bump foils 200, the divided outer top foils 300a, and the divided inner top foils 300b may be configured as the free end. Therefore, one bump foil 200, one outer top foil 300a, and one inner top foil 300b, which are disposed in angle ranges corresponding to one another, may define a group of foils. In this case, the other end of each of the outer and inner top foils 300a and 300b in one group may be disposed to overlap one side of the inner top foil 300b in another group.

In this case, one fixed end of each of the bump foil 200 and the outer and inner top foils 300a and 300b in one group may be disposed at the upper side of the bearing housing 100, and one fixed end of each of the bump foil 200 and the outer and inner top foils 300a and 300b in another group may be disposed at the upper side of the bearing housing 100. Therefore, the third embodiment of the present invention may have all the effects of the first and second embodiments.

The present invention is not limited to the above-mentioned embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

100: Bearing housing
110: Hollow portion
120: Key groove
200: Bump foil
210: Elastic bump
300a: Outer top foil
300b: Inner top foil
310a, 310b: Bent portion
320a, 320b: Connection portion
330a, 330b: Curved portion
400: Top foil key
500: Rotor

What is claimed is:

1. An airfoil journal bearing comprising:
a bump foil provided inside a bearing housing, formed in a circumferential direction, and coupled to the bearing housing; and
a top foil provided inside the bump foil, formed in the circumferential direction, and having one end, based on the circumferential direction, fixedly coupled to the bearing housing, and the other end configured as a free end,
wherein the other end, which is the free end of the top foil, is formed to exceed one end in a direction in which the top foil extends based on one end fixed to the bearing housing, such that the other end of the top foil is disposed to overlap one side in the circumferential direction.

2. The airfoil journal bearing of claim 1, wherein the top foil is provided as two or more top foil including an outer top foil and an inner top foil disposed inside the outer top foil, and the other end of each of the outer and inner top foils is disposed to overlap one side of the inner top foil.

3. The airfoil journal bearing of claim 2, wherein directions in which the outer and inner top foils extend are identical to each other based on one end fixed to the fixed bearing housing

4. The airfoil journal bearing of claim 2, wherein an overlap angle range θi of the inner top foil in which the other end of the inner top foil overlaps one side of the inner top foil is larger than an overlap angle range θo of the outer top foil in which the other end of the outer top foil overlaps one side of the inner top foil.

5. The airfoil journal bearing of claim 4, wherein the overlap angle range θi of the inner top foil is 12 to 15 degrees, and the overlap angle range θo of the outer top foil is 5 to 7 degrees.

6. The airfoil journal bearing of claim 2, wherein the free end of the outer top foil and the free end of the inner top foil are in contact with and supported on an inner circumferential surface of one side of the inner top foil.

7. The airfoil journal bearing of claim 1, wherein one fixed end of the top foil is disposed at a lower side of the bearing housing.

8. The airfoil journal bearing of claim 1, wherein one fixed end of the top foil is disposed at an upper side of the bearing housing.

9. The airfoil journal bearing of claim 1, wherein the top foil extends to exceed 360 degrees in the circumferential direction based on one fixed end.

10. The airfoil journal bearing of claim 1, wherein the bump foil and the top foil are divided into two or more foils in the circumferential direction, a range of each of the divided bump foils and the divided top foils is less than 360 degrees, one end of each of the divided bump foils and the divided top foils is coupled to the bearing housing, the other end of each of the divided bump foils and the divided top foils is configured as a free end, and the other end of one top foil is disposed to overlap one side of adjacent another top foil.

11. The airfoil journal bearing of claim 10, wherein among the divided top foils, one fixed end of one top foil is disposed at a lower side of the bearing housing, and one fixed end of another top foil is disposed at an upper side of the bearing housing.
